(19) United States
(12) Patent Application Publication
(10) Pub. No.: US 2009/0314151 A1
(43) Pub. Date: Dec. 24, 2009

(54) Drive mechanism of sawing machine for woodworking

(75) Inventor: Tian-Wang Wang, Taichung Hsien (TW)

Correspondence Address: Tian-Wang Wang, P.O. Box 44-2049, Taipei, 10668, TW

(73) Assignee: Mao Shan Machinery Industrial Co., Ltd.

(21) Appl. No.: 12/213,596

(22) Filed: Jun. 23, 2008

(51) Int. Cl. B26D 5/00

(52) U.S. Cl. 83/755; 83/781; 83/477

(57) ABSTRACT

The present invention provides an improved drive mechanism of the sawing machine for woodworking, which allows to install the integrated drive motor and sawing device onto the moveable mount of the fixed motor, so that the screw rod arranged at one side of two lifting rods enables lifting control to achieve most reliable lifting and stroke of entire saw blade set.

### BACKGROUND OF INVENTION

(1) Field of the Invention

The present invention relates generally to a drive mechanism of sawing machine for woodworking, and more particularly to an innovative one which permits to install a drive motor and sawing device onto the moveable mount of a fixed motor, and mount additionally a lifting screw laterally onto the moveable shelf, thus realizing reliable vertical lifting of the sawing blade set and improving the unbalance of mechanical operation.

(2) Description of the Prior Art

Currently, the sawing blade set of the sawing machine for woodworking is linked with the motor drive device for enabling vertical lifting, as shown in U.S. Pat. No. 6,959,631 B2 and 7,047,854 B2. When the motor and saw blade lift vertically in the sawing process, since one of equalizing bars at both sides of the motor seat is provided with a drive gear, the connecting screw and rotating handle are controlled in a manner that the equalizing bar could drive the lifting of the entire frame for simplified and space-saving operation.

However, the main shortcoming of this design is that the lifting rod has to maintain the lifting of the frame and also enable rotation during lifting process, leading to possible unbalanced and unsmooth movement of two lifting rods; if the saw blade is fine-tuned during the sawing process, the unbalance of two lifting rods may lead to defective sawing and even damage of the saw blade set.

### SUMMARY OF THE INVENTION

To overcome the aforementioned shortcoming, the inventor developed an improved sawing machine for woodworking. The major purpose of the present invention is to mount additionally a screw mechanism at one side of two lifting rods, thus shaping an independent lifting drive mechanism by the screw mechanism, drive rod and rotating handle; furthermore, two lifting rods are only used for balancing the lifting movement of entire set for optimized balance and smooth operation.

Another objective of the present invention is to achieve most convenient and safe operation of the lifting saw blade through the drive of additional screw under any circumstance.

### BRIEF DESCRIPTION OF THE DRAWINGS

FIG. 1 depicts a schematic view of sawing device of the present invention without saw blade.

FIG. 2 depicts an exploded view of sawing device of the present invention with saw blade.

FIG. 3 depicts a falling schematic view of the moveable shelf of the present invention.

FIG. 4 depicts a rising schematic view of the moveable shelf of the present invention.

### DETAILED DESCRIPTION OF THE PREFERRED EMBODIMENTS

The structure and efficacy of the present invention will be more readily understood with reference to the accompanying drawings:

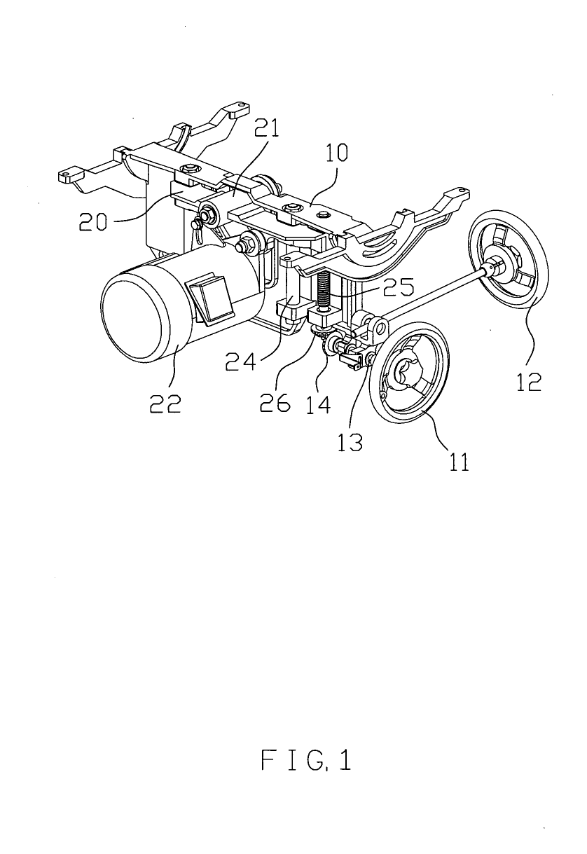

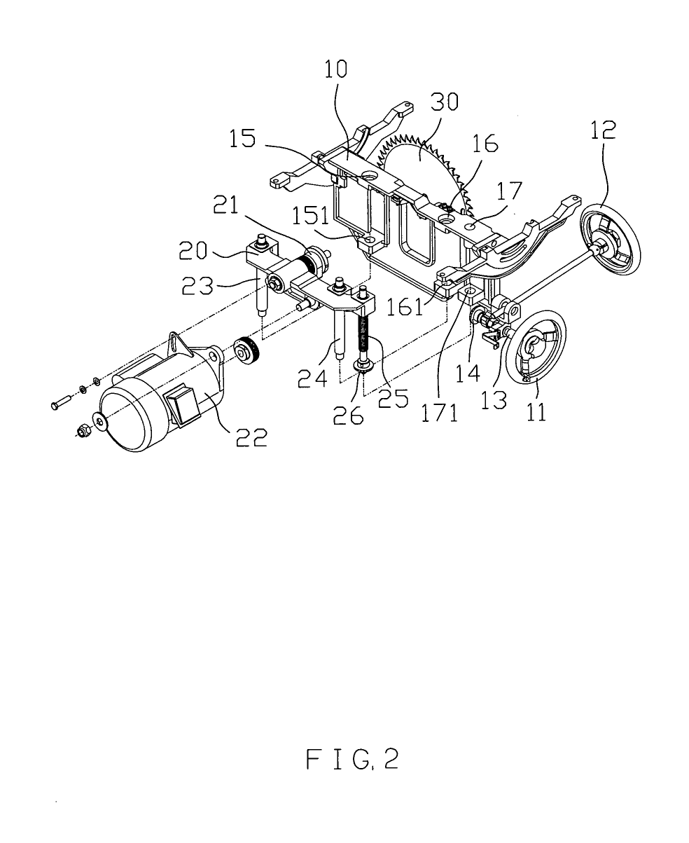

Firstly, referring to FIG. 1—schematic view of the sawing device of present invention without saw blade, and FIG. 2—exploded view of the sawing device of present invention with saw blade, wherein a moveable mount 20 is arranged at inner side of the fixed mount 10 of main body; the moveable mount 20 is provided with a drive motor 22 and also a drive device 21 connected with saw blade 30 in the front of the fixed mount 10; with the use of two lifting rods 23, 24 arranged correspondingly onto the moveable mount 20, this allows them to be fixed separately into two preset holes 15, 151, 16, 161 of the fixed mount 10, enabling the moveable mount 20 (including motor 22) to lift vertically within the limited range of fixed mount 10 so as to drive the lifting of saw blade 30.

With the screw rod 25 externally placed onto the lifting rod 24, the moveable mount 20 is arranged between preset holes 17, 171 of the fixed mount 10, and engaged with the drive gear 14 at end of connecting rod 13 of the handle 11 via the lower drive gear 26; the screw rod 25 rotate synchronously with the positive and reverse rotation of the handle 11, thus driving the synchronous lifting of entire moveable mount 20 and saw blade 30.

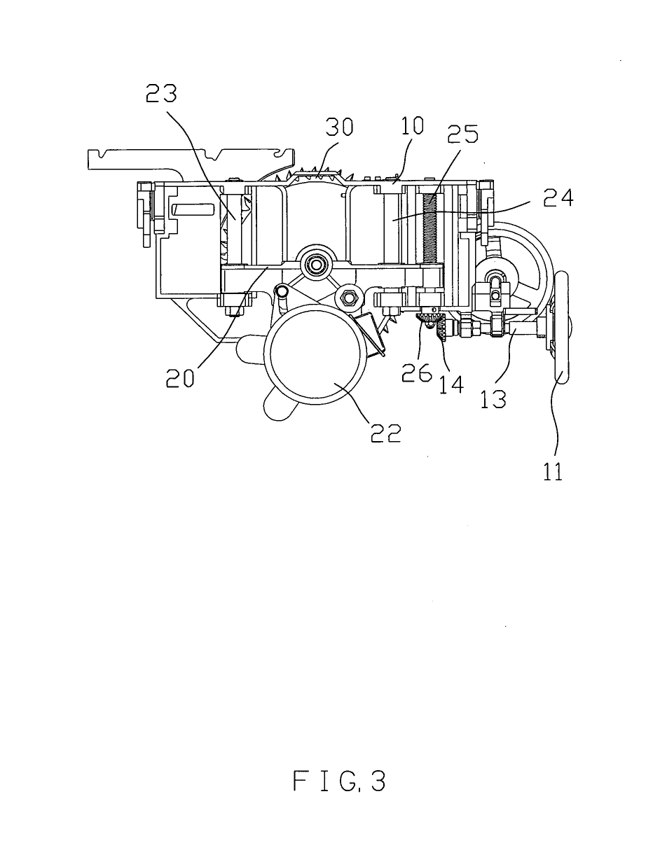

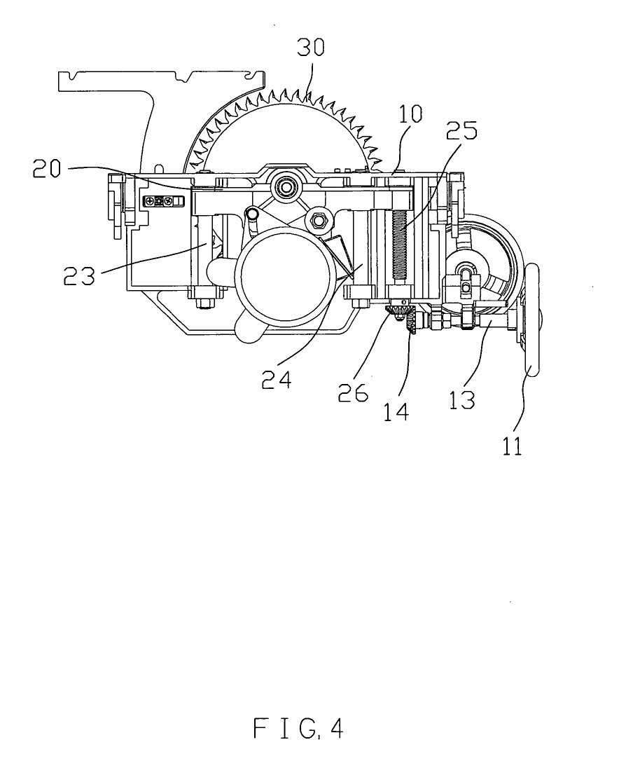

Referring also to FIG. 3—the falling schematic view of the moveable shelf in relation to the fixed mount, and FIG. 4—the rising schematic view of the moveable shelf, when the moveable mount 20 falls in relation to the fixed mount 10 under the action of the handle 11, connecting rod 13 and drive gears 14, 26, the motor 22 and saw blade 30 also fall with the rotation of the screw rod 25. During counterclockwise rotation of the handle 11, the screw rod 25 will drive the moveable mount 20 to rise up as shown in FIG. 4. The saw blade 30 will cut the timber if the motor 22 is rotated.

If the drive gear is installed directly onto the lifting rod 24 to drive the lifting of the moveable mount 20, two lifting rods will lead to unbalance since the lifting rod 24 on the moveable mount 20 is under a rotating state; so the present invention allows a screw rod 25 to be additionally installed onto the lifting rod 24 for driving two lifting rods in an absolutely balanced state. This makes it possible to operate the moveable mount 20 smoothly, and prevent any safety hazard arising from any improper lifting during the operation of saw blade 30.

What is claimed is:

1. An improved drive mechanism of sawing machine for woodworking, wherein a screw rod is additionally installed at one side of two lifting rods of the moveable shelf linking the drive motor and saw blade; by coupling the drive gear at lower end of the screw rod with the drive gear of the moveable handle, the screw rod will drive the moveable shelf to lift vertically within the limited range of the fixed mount.

2. The improved device defined in claim 1, wherein said screw rod is limited into the preset hole on the fixed mount.
